(19) United States
(12) Patent Application Publication
(10) Pub. No.: US 2021/0003396 A1
(43) Pub. Date: Jan. 7, 2021

(54) METHOD FOR ESTIMATING NAVIGATION DATA OF A LAND VEHICLE USING ROAD GEOMETRY AND ORIENTATION PARAMETERS

(71) Applicant: SAFRAN ELECTRONICS & DEFENSE, Boulogne-Billancourt (FR)

(72) Inventors: Michel DESTELLE, Boulogne-Billancourt (FR); Jean Luc DEMANGE, Boulogne-Billancourt (FR)

(73) Assignee: SAFRAN ELECTRONICS & DEFENSE, Boulogne-Billancourt (FR)

(21) Appl. No.: 16/772,294

(22) PCT Filed: Dec. 14, 2018
(86) PCT No.: PCT/FR2018/053312

§ 371 Date: Jun. 12, 2020

(30) Foreign Application Priority Data
Dec. 14, 2017 (FR) 1762167

(51) Int. Cl. G01C 21/16; G01C 21/34; G06F 17/12

(52) U.S. Cl. CPC G01C 21/165; G06F 17/12; G01C 21/34; G01C 21/188

(57) ABSTRACT

The invention concerns a method for estimating navigation date of a land vehicle, comprising steps of: recciving inertial data (100) acquired by an inertial sensor, receiving geometry and orientation parameters of a travelled road, integrating (106) the data on the basis of the parameters in order to produce navigation data comprising a movement of the vehicle relative to the road measured in a direction (Zr, Yr), the vehicle only being able to move in the direction within a bounded interval without leaving the road, estimating (108) an error affecting the navigation data by sol ing equations assuming that a difference between the calculated movement and a reference movement constitutes an error in the movement of the vehicle parallel to the direction, the reference movement having a value less than or equal to the length of the interval, correcting (110) the produced navigation data from the estimated error.

### FIELD OF THE INVENTION

The present invention relates to a method and a device for estimating navigation data of a land vehicle.

### PRIOR ART

For estimating navigation data of a carrier (position, speed, attitude), it is known to embed in such a vehicle an INS (Inertial Navigation System).

At present, the position data of a carrier on the base of the inertial data supplied by an inertial system has a precision, in pure inertia, in the order of 1 Nm/h.

There are however applications wherein it is desirable to obtain a higher degree of precision.

To obtain such an increase in precision, it has been proposed to combine the inertial data produced by an inertial system with an item of information external to the carrier.

To do this, inertial measurements are first implemented to estimate a position of the carrier, then, in order to correct any errors on this estimate, this item of external information is used, the item being supplied by another system. Such navigation systems are thus currently denoted by the term “hybrid systems”.

By way of example, systems of this type are known wherein said correction is implemented using data coming from a GNSS radio navigation system (external item of information). However, a known problem is that radio navigation systems are not exempt from possible scrambling attacks. In this case, the inertial navigation system can no longer count on the items of GNSS information to calibrate itself on the correct position.

Of course, solutions are known to remedy this drawback.

In the case of a carrier of land vehicle type (for example a motor vehicle), the item of external information can come from an odometer onboard the vehicle.

An item of data about the distance travelled by the vehicle is then used, supplied by the odometer and considered as relatively reliable, to correct the navigation data deduced from the inertial data.

Although a system of this type responds to the problems raised to some extent, particularly for motor vehicles, the fact remains that its integration can present difficulties.

Firstly, the adaptation of a system of this type to the vehicle often poses problems, particularly as regards a good reception of the signal transmitted by the odometer. Such a reception quality for example requires design efforts at the level of the electronic circuits given the diversity of form that signals can have.

Secondly, due to restrictions related to the environment of the vehicle (deformation of the terrain, ascent, descent etc.), the vehicle is caused to deform in different directions of the space.

For example if one considers a component of movement parallel to the direction of driving of the vehicle, the latter can deform along this component (suspension stressed etc.), which leads to a deterioration in the relevance of the comparison of the odometer measurements with the integrated inertial measurements.

There are thus other solutions making it possible to obtain a good positioning performance in the absence of a radio navigation or odometer system.

For example, another solution exists, known by the acronym ZUPT for Zero velocity Update, consists in periodically stopping the carrier in such a way that the speed in axes of the space are zero and in using this information. This solution is often denoted by the expression “zero-speed hybridizing”. By proceeding in this way, the inertial navigation system is capable of estimating the errors caused by the sensors and thus improving the performance, particularly of position. However, these periodic stops (every 4 to 10 minutes depending on the desired performance) sometimes impose heavy operational restrictions. For example, in the case of a military carrier in combat phase, it can be awkward to stop to implement zero-speed hybridizing.

To solve these problems, the document FR2878954 proposes a method for estimating navigation data of a land vehicle making it possible to achieve good positioning performance, and without having recourse to a radio navigation or odometer system. This method in particular uses a kinetic model of the vehicle, i.e. a model making it possible to predict the behavior of the vehicle (behavior in maneuvers, behavior in turns, articulated or caterpillar vehicle). However, such a kinetic model needs to be particularly complex to be effective.

### EXPLANATION OF THE INVENTION

An aim of the invention is to overcome the drawbacks mentioned above.

According to a first aspect of the invention, there is hence proposed a method for estimating navigation data of a land vehicle, the method comprising steps of:
receiving inertial data acquired by an inertial sensor embedded in the land vehicle,
receiving parameters relating to the geometry and orientation of a road travelled by the land vehicle,
integrating the inertial data on the basis of the parameters, such as to produce navigation data of the vehicle comprising at least one movement of the vehicle with respect to the road measured parallel to a direction, wherein the vehicle can only move, parallel to the direction, in a bounded interval without leaving the road,
estimating at least one error that affects the produced navigation data, by solving a system of equations making the assumption that a deviation between the computed movement and an associated reference movement constitutes an error of movement of the vehicle parallel to the chosen direction, the reference movement associated with the computed movement having a value less than or equal to the length of the bounded interval,
correction of the navigation data produced on the basis of the estimated error, such as to produce corrected navigation data.

The method according to the first aspect of the invention can comprise the following optional features or steps, taken alone or in combination when this is technically possible.

In a first embodiment, the road parameters comprise a width of the road measured along a transverse direction perpendicular to an average direction of circulation of a land vehicle on the road. In this case, the navigation data of the vehicle produced during the integrating step comprises a transverse movement of the vehicle measured parallel to the transverse direction, and the reference movement associated with the transverse movement is of a value less than or equal to the width of the road.

The reference movement associated with the transverse movement can be of zero value.

In a second embodiment, the navigation data of the vehicle produced during the integrating step comprises a vertical movement of the vehicle measured parallel to a direction perpendicular to a surface of the road, in which case the reference movement associated with the vertical movement is of zero value.

The first embodiment, making use of a transverse movement, and the second embodiment, making use of a vertical movement, are two alternative solutions to the general problem posed above.

The first embodiment and the second embodiment can be combined to form a third embodiment, wherein: the two aforementioned types of movement (transverse and vertical) are computed, the corresponding errors are estimated by solving the system of equations, which makes two assumptions (that the computed vertical movement constitutes an error of movement of the vehicle parallel to the vertical movement, and that the computed deviation constitutes an error of movement of the vehicle parallel to the transverse direction).

The estimating step can be implemented by a Kalman filter, and the movement of the vehicle parallel to the chosen direction can be used by the Kalman filter as an item of observation data.

The method can comprise steps of receiving satellite radio navigation data, and image correlating implemented between the satellite radio navigation data and road data stored by a memory embedded in the vehicle, such as to produce the parameters relating to the geometry and orientation of the road.

When satellite radio navigation data cannot be received, the correlating step can be implemented between corrected navigation data resulting from a previous implementation of the correcting step, and the road data can be stored by the memory.

According to a second aspect of the invention, there is also proposed a computer program product comprising program code instructions for executing the steps of the method according to the first aspect of the invention, when this method is executed by at least a processor.

According to a third aspect of the invention, there is also proposed a device for estimating navigation data of a land vehicle, the device comprising:
an interface for receiving inertial data acquired by at least one inertial sensor embedded in the land vehicle,
an interface for receiving parameters relating to the geometry and orientation of a road travelled by the land vehicle,
at least one processor configured for:
   integrating the inertial data on the basis of the parameters, such as to produce navigation data of the vehicle comprising at least one movement of the vehicle with respect to the road measured parallel to a chosen direction such that the vehicle can only move, parallel to the direction, within a bounded interval without leaving the road,
   computing a deviation between the computed movement and an associated reference movement having a value contained within the bounded interval,
   estimating at least one error that affects the produced navigation data, by solving a system of equations making the assumption that the computed deviation constitutes an error of movement of the vehicle parallel to the chosen direction,
   correcting the navigation data produced on the basis of the estimated error, such as to produce corrected navigation data.

According to a fourth aspect of the invention, there is also proposed a system intended to be embedded in a land vehicle, comprising an inertial system comprising at least one inertial sensor, a device according to the third aspect of the invention and arranged to receive inertial data generated by the inertial system by means of the inertial sensor.

According to a fifth aspect of the invention, there is also proposed a system intended to be embedded in a land vehicle, comprising:
a memory containing road data,
a receiver configured for acquiring satellite radio navigation data,
a correlating device configured for implementing a correlation between the satellite radio navigation data and the road data contained in the memory, such as to produce parameters relating to the geometry and orientation of a road,
a device according to the third aspect of the invention, arranged to receive the parameters produced by the correlating device.

According to a sixth aspect of the invention, there is also proposed a land vehicle comprising a device according to the third aspect of the invention, or a system according to the fourth or fifth aspect of the invention.

### DESCRIPTION OF THE FIGURES

Other features, aims and advantages of the invention will become apparent from the following description, which is purely illustrative and non-limiting, and which must be read with reference to the appended drawings wherein:

FIGS. 1a, 1b, 1c: are respectively side, front and top views of a land vehicle moving on a road.

FIG. 2 schematically represents a navigation system according to an embodiment of the invention.

FIG. 3 details the steps of a method implemented by the system represented in FIG. 2, according to an embodiment of the invention.

In all the figures, similar elements bear identical reference numbers.

### DETAILED DESCRIPTION OF THE INVENTION

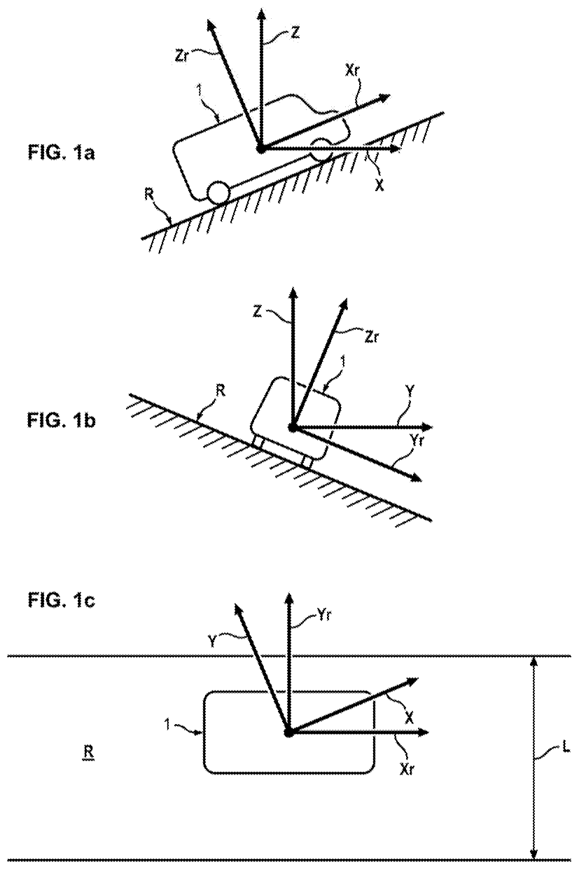

FIGS. 1a to 1c show a vehicle 1 on a road R as well as two reference frames: a local geographical reference frame and a road reference frame.

The origin of the local reference frame is a predetermined point of the vehicle. The geographical reference frame comprises three axes X, Y, Z:
the axis X is a horizontal axis pointing to the geographical North of the Earth,
the axis Y is a horizontal axis pointing to the geographical West, and
the axis Z is orthogonal to the axes X and Y, and oriented toward the zenith.

Moreover, the road reference frame comprises three axes Xr, Yr, Zr:
the axis Xr is a longitudinal axis parallel to a main direction of circulation of a vehicle along the road,
the axis Yr is a transverse axis perpendicular to the axis Xr; the two axes Xr and Yr defining a plane wherein the road extends,
the axis Zr is an axis vertical to the plane defined by the axes Xr, Yr, so perpendicular to the road surface.

The origin of the road reference frame is for example the same as that of the local geographical reference frame.

The road has geometrical and orientation parameters. These road parameters are generally well-known and are for example, in France, subject to regulations which must be taken into account when designing roads (see for example the document titled “Comprendre les principaux paramètres de conception géométrique des routes”, Sétra 2006).

The road parameters typically comprise:
a longitudinal slope angle,
an angle of cant or of transverse slope,
an angle of heading of the road,
a road width L.

The road parameters mentioned above make it possible to pass from the local geographical reference frame or vice versa.

The respective directions of the axes Yr and Zr are particular. Specifically, if one assumes that the vehicle is moving on the road without ever leaving it, then the movement of the vehicle parallel to one of the axes Yr and Zr is of necessity bounded.

In particular, as the land vehicle is not capable of flying, the movement of the vehicle parallel to the axis Zr is assumed to be zero, or on average zero if one takes into consideration oscillations of the vehicle along the axis Zr caused by any suspension of this vehicle.

Moreover, the movement of the vehicle along a transverse direction—i.e. parallel to the axis Yr—is limited by two opposite lateral edges of the road. Hence, a transverse movement is intended to be contained within an interval bounded by these two opposite edges (this interval is therefore of a length equal to one road width).

On a straight portion of a journey, a vehicle can in particular effect body movements which in real time cause small movements along the axes Yr and Zr. However, over the time period needed to travel said journey portion, these movements are on average zero, since the vehicle always returns to an equilibrium position both along Yr and along Zr.

Of course, this is also valid for a road portion in a turn or on a slope.

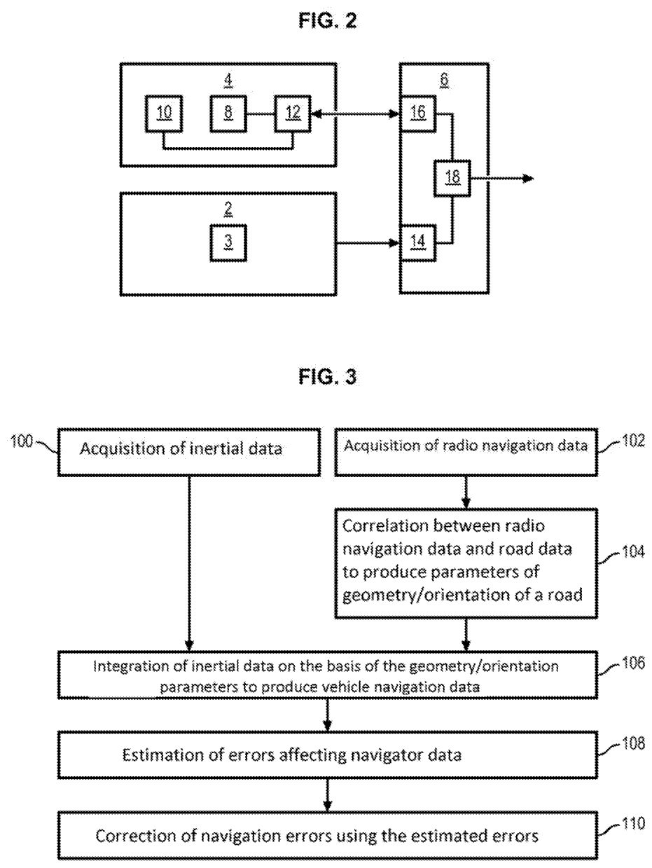

With reference to FIG. 2, the vehicle 1 comprises a navigation system comprising an inertial navigation system 2.

The inertial navigation system 2 comprises, in a manner known per se, a plurality of inertial sensors 3, typically gyroscopes and accelerometers (a single one of them being illustrated in FIG. 2).

The navigation system moreover comprises a system 4 for supplying geometrical and orientation road parameters, and a data fusion device 6.

The system 4 for supplying parameters comprises a receiver of radio navigation signals 8, a memory 10 and a correlating device 12.

The receiver 8 is known per se. It comprises an antenna configured for receiving signals emitted by one or more satellites (GPS/GNSS signals typically). The receiver 8 moreover comprises at least one processor configured for generating radio navigation data on the basis of signals received by the antenna (typically a vehicle position estimation) and delivering this data to the correlating device 12.

Moreover, the memory 10 contains a road database containing geometrical information about the roads of a geographical area wherein the vehicle is intended to be moving, such as the road represented in FIGS. 1 to 3.

The information stored in the database is typically geometrical equation parameters (line segment, clothoids), which offers the advantage of consuming little memory space.

The correlating device 12, also known per se, is configured for implementing a correlation processing known per se known as map matching, this correlation being made between the data supplied by the receiver 8 and data contained in the road database stored in the memory 8.

The fusion device 6 moreover comprises an interface 14 able to receive data from the inertial navigation system 2, and an interface 16 able to receive data computed by the correlating device 12 of the supplying system 4.

The fusion device 6 is configured for estimating vehicle navigation data (position, speed, attitude) on the basis of the data it receives via its interfaces.

The fusion device typically comprises a processor 18 configured for executing a program providing such a data estimate.

It should also be noted that the fusion device is also able to transmit data to the correlating device 12. It will be seen that such a transmission is advantageously implemented in the absence of reception by the receiver of any radio navigation signal.

With reference to FIG. 3, the following steps are implemented by the navigation system, when the vehicle 1 is moving on the road R.

The inertial system 2 acquires inertial data using its inertial sensors (step 100).

The inertial system 2 transmits the acquired inertial data to the fusion device 6.

Moreover, the receiver 8 receives radio navigation signals transmitted by satellites and generates radio navigation data on the basis of the received signals.

The correlating device 12 implements a correlation process between the radio navigation data supplied by the receiver and road data contained in the road database stored in the memory 10, such as to generate parameters relating to the geometry and the orientation of the road travelled by the land vehicle (step 104).

These parameters in particular comprise the width L of the road, or even the angles of cant, slope and heading mentioned above.

The system 4 for supplying parameters transmits the geometry and orientation parameters generated to the fusion device 6.

The fusion device 6 implements the following steps for estimating the navigation data of the land vehicle 1 (this navigation data can for example comprise a position, a speed, and an attitude of the vehicle in the local geographical reference frame).

The fusion device 6 integrates the inertial data on the basis of the parameters received from the supplying system 4, such as to produce navigation data of the vehicle. The integrating computation is carried out over a time interval of predetermined duration.

This navigation data of the vehicle comprises at least one movement of the vehicle with respect to the road R measured parallel to a direction, wherein the vehicle can only move, parallel to the direction, within a bounded interval without leaving the road.

The navigation data comprises a vertical movement of the vehicle with respect to the road R, i.e. measured parallel to the axis Zr. As has previously been said, this vertical movement is assumed to be zero or on average zero, since the vehicle cannot fly.

This navigation data further comprises a transverse movement of the vehicle with respect to the road R, i.e. measured parallel to the axis Yr. This transverse movement is, as indicated previously, limited by two opposite lateral edges of the road R. Hence, the transverse movement is contained within an interval of length equal to the width of the road as long as the vehicle is on the road R.

The fusion device 6 then estimates at least one error that affects the navigation data produced during the integrating step, by solving a system of equations making certain assumptions.

For at least one movement computed during the integrating step, the assumption is made by the fusion device 6 that a deviation between the computed movement and a reference movement associated with this computed movement constitutes an error of movement of the vehicle parallel to the direction of the movement under consideration. The reference movement associated with the computed movement has a value less than or equal to the length of the bounded interval under consideration.

When the navigation data produced during the integrating step 106 comprises a vertical movement and a transverse movement, the system of equations makes two assumptions, one for each computed movement.

The transverse reference movement associated with the computed transverse movement has a value less than or equal to the width of the road. In other words, the system of equations makes the assumption that the vehicle does not cross one of the two lateral sides of the road it is travelling on. The value of the transverse reference movement is for example zero.

Moreover, the vertical reference movement associated with the computed vertical movement is zero. In other words, the system of equations makes the assumption that the vehicle does not fly.

The fusion device 6 then corrects the navigation data produced using the error or errors estimated by solving the system of equations (step 110).

The preceding steps are repeated over time, on the basis of new radio navigation signals received by the receiver and/or new inertial data produced by the inertial navigation system.

It may be that satellite radio navigation data cannot be received (for example when the vehicle is passing through a tunnel).

When an absence of radio navigation signals is detected, the image correlating step is implemented between corrected navigation data resulting from a previous implementation of the correcting step 12, and the road data stored by the memory.

In an embodiment, the fusion device 6 implements a Kalman filter for estimating the navigation data of the vehicle.

The operation of a Kalman filter is known per se (its principle is in particular described in the document “Applied Optimal Estimation”, The Analytic Sciences Corporation, Ed. Arthur Gelb, 1974). As a reminder, a Kalman filter recursively estimates a state X, taking the form of a vector. The Kalman filter has two separate phases: a prediction phase, and an updating phase.

The prediction phase takes as input an estimated state produced during a previous iteration of the filter, and uses a transition matrix to produce an estimate of the state, called the predicted state.

In the updating step, observations are used to correct the state predicted in the aim of obtaining a more precise estimate. For this purpose, an observation matrix linking the state with the observations is used. The updated estimate is passed as input to the step of prediction of a subsequent iteration of the filter, and so on.

In this case, the Kalman filter is configured with a state vector X governed by the following equations:

$$\frac{d X}{d t} = f ( X , t )$$

$$\frac{d δ X}{d t} = F \cdot δ X$$

where f is a non-linear function, and t denotes time. F is moreover the dynamic matrix of the Kalman filter. It is obtained by linearization of the first equation mentioning the function f. Among the components of the vector δX, it is possible to find: at least the 3 components of the associated position error with respect to the linearization point, the 3 components of the associated speed error with respect to the linearization point and the 3 components of the associated attitude error with respect to the linearization point.

The state vector δX is thus for example as follows in an embodiment:

$$δ X = [ \begin{matrix}δ Lat \\ δ G \\ δ Z \\ δ Vx \\ δ Vy \\ δ Vz \\ {ϕ}_{x} \\ {ϕ}_{y} \\ {ϕ}_{z} \\ δ {b}_{xm} \\ δ {b}_{ym} \\ δ {b}_{zm} \\ δ {d}_{xm} \\ δ {d}_{ym} \\ δ {d}_{zm} \\ δ {dep}_{Yr} \\ δ {dep}_{Zr}\end{matrix} ]$$

where
δLat is a latitude error (rad)
δG is a longitude error (rad)
δZ is an altitude error (m)
δVx is an error of speed along the axis Xg (m/s)
δVy is an error of speed along the axis Yg (m/s)
δVz is an error of speed along the axis Zg (m/s)
φₓ is an error of attitude along the axis Xg (rad)
φ_{y} is an error of attitude along the axis Yg (rad)
φ_{z} is an error of attitude along the axis Zg (rad)
δbₓₘ is an error of accelerometer bias along the axis Xm (m/s²)
δb_{ym} is an error of accelerometer bias along the axis Ym (m/s²)
δb_{zm} is an error of accelerometer bias along the axis Zm (m/s²)
δdₓₘ is an error of gyroscope drift along the axis Xm (rad/s)
δd_{ym} is an error of gyroscope drift along the axis Ym (rad/s)
δd_{zm} is an error of gyroscope drift along the axis Zm (rad/s)
δdep_{Yr} is an error of movement along the axis Yr of the road reference frame (m)
δdep_{Zr} is an error of movement along the axis Zr of the road reference frame (m)

In this case, the transition matrix F is written:

$$F = [ \begin{matrix}0 & 0 & 0 & \frac{1}{R} & 0 & 0 & 0 & 0 & 0 & 0 & 0 & 0 & 0 & 0 & 0 & 0 & 0 \\ 0 & 0 & 0 & 0 & - \frac{1}{R cos L at} & 0 & 0 & 0 & 0 & 0 & 0 & 0 & 0 & 0 & 0 & 0 & 0 \\ 0 & 0 & 0 & 0 & 0 & 1 & 0 & 0 & 0 & 0 & 0 & 0 & 0 & 0 & 0 & 0 & 0 \\ 0 & 0 & 0 & 0 & 2 {Ω}_{t} sin Lat & - 2 {Ω}_{t} sin Lat & 0 & - {G}_{0} & sc \cdot {fa}_{m x} & - cc & sc & 0 & 0 & 0 & 0 & 0 & 0 \\ 0 & 0 & 0 & - 2 {Ω}_{t} sin Lat & 0 & - 2 {Ω}_{t} sin Lat & {G}_{0} & 0 & cc \cdot {fa}_{mx} & sc & cc & 0 & 0 & 0 & 0 & 0 & 0 \\ 0 & 0 & \frac{2 {G}_{0}}{R} & 0 & - 2 {Ω}_{t} cos Lat & 0 & - sc \cdot {fa}_{mx} & - cc \cdot {fa}_{m x} & 0 & 0 & 0 & 1 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 \\ 0 & 0 & 0 & - sr & - cr & 0 & 0 & 0 & 0 & 0 & 0 & 0 & 0 & 0 & 0 & 0 & 0 \\ 0 & 0 & 0 & 0 & 0 & 1 & 0 & 0 & 0 & 0 & 0 & 0 & 0 & 0 & 0 & 0 & 0\end{matrix} ]$$

where:
Lat is a latitude of the vehicle (rad)
fαₓ_{ₘ} is a force measured by an accelerometer along the axis Xg (m/s²)
fα_{y}_{ₘ} is a force measured by an accelerometer along the axis Yg (m/s²)
fα_{z}_{ₘ} is a force measured by an accelerometer along the axis Zg (m/s²)
Ωₜ is an angular rotation speed of the Earth (radis)
G₀ is a value of the average gravity (m/s²)
cc is the cosine of the heading of the vehicle
sc is the sine of the heading of the vehicle
cr is the cosine of the heading of the road
sr is the sine of the heading of the road
R is the Earth's radius

During the prediction step, the Kalman filter computes the predicted state using the dynamic matrix F.

The Kalman filter moreover uses as observation the movement along the axis Yr and the movement along the axis Zr. In this case, the observation matrix H of the Kalman filter is written:

$$H = [ \begin{matrix}0 & 0 & 0 & 0 & 0 & 0 & 0 & 0 & 0 & 0 & 0 & 0 & 0 & 0 & 0 & 1 & 0 \\ 0 & 0 & 0 & 0 & 0 & 0 & 0 & 0 & 0 & 0 & 0 & 0 & 0 & 0 & 0 & 0 & 1\end{matrix} ]$$

The innovation of the Kalman filter is then computed.

The innovation is, in a manner known per se, a deviation between reference data and data observed by the filter.

The innovation “Inno” is for example as follows:

$$Inno = [ \begin{matrix}0 \\ 0\end{matrix} ] - [ \begin{matrix}{dep}_{y r} \\ {dep}_{zr }\end{matrix} ]$$

With:

dep_{yr}: Movement of the vehicle along the y axis of the road reference frame

dep_{zr}: Movement of the vehicle along the z axis of the road reference frame

$$[ \begin{matrix}{dep}_{y r} \\ {dep}_{zr }\end{matrix} ] = [ \begin{matrix}{\int }_{0}^{t} ( - sr \cdot Vx - cr \cdot Vy ) dt \\ {\int }_{0}^{t} Vz \cdot dt\end{matrix} ]$$

In this computation, the two-component zero vector is the reference movement vector discussed above. The innovation of the Kalman filter therefore corresponds to a vector of deviations between a vector of computed movements and a vector of zero reference movements. The use of this innovation by the Kalman filter during its implementation is illustrative of the assumptions made, namely that the vehicle is not leaving the road by moving along the axes Yr and Zr.

1. A method for estimating navigation data of a land vehicle, the method comprising:
receiving inertial data acquired by an inertial sensor embedded in the land vehicle,
receiving parameters relating to a geometry and an orientation of a road travelled by the land vehicle,
integrating the inertial data on the basis of the parameters, such as to produce navigation data of the vehicle comprising at least one movement of the vehicle measured parallel to a direction perpendicular to a surface of the road,
estimating at least one error that affects the produced navigation data, by solving a system of equations making the assumption that the at least one movement of the vehicle constitutes an error of movement of the vehicle parallel to the vertical direction,
correcting the navigation data produced on the basis of the at least one error, such as to produce corrected navigation data.

2. A method for estimating navigation data of a land vehicle, the method comprising:
receiving inertial data acquired by an inertial sensor embedded in the land vehicle,
receiving parameters relating to a geometry and an orientation of a road travelled by the land vehicle, wherein the parameters comprise a width of the road measured along a transverse direction perpendicular to an average direction of circulation of a land vehicle on the road,
integrating the inertial data on the basis of the parameters, such as to produce navigation data of the vehicle comprising at least one movement of the vehicle with respect to the road measured parallel to the transverse direction,
computing a deviation between the at least one movement of the vehicle and an associated reference movement having a predetermined value less than or equal to the width of the road,
estimating at least one error that affects the produced navigation data, by solving a system of equations making the assumption that the deviation constitutes an error of movement of the vehicle parallel to the transverse direction,
correcting the navigation data produced on the basis of the at least one error, such as to produce corrected navigation data.

3. The method as claimed in claim 2, wherein the reference movement associated with the transverse movement is of zero value.

4. The method as claimed in claim 1 or claim 2, wherein estimating the at least one error is implemented by a Kalman filter, and the at least one movement of the vehicle is used by the Kalman filter as an item of observation data.

5. The method as claimed in claim 1 or claim 2, comprising steps of
receiving satellite radio navigation data,
image correlating implemented between the satellite radio navigation data and road data stored by a memory embedded in the vehicle, such as to produce the parameters relating to the geometry and orientation of the road.

6. The method as claimed in claim 5, wherein, when satellite radio navigation data cannot be received, the correlating step is implemented between corrected navigation data resulting from a previous implementation of the correcting step, and the road data stored by the memory.

7. A non-transitorv computer-readable medium comprising code instructions for causing a processor to perform the method as claimed in claim 1 or claim 2.

8. A device for estimating navigation data of a land vehicle, the device comprising:
an interface for receiving inertial data acquired by at least one inertial sensor embedded in the land vehicle,
an interface for receiving parameters relating to a geometry and an orientation of a road travelled by the land vehicle,
at least one processor configured to:
integrate the inertial data on the basis of the parameters, such as to produce navigation data of the vehicle comprising at least one movement of the vehicle with respect to the road measured parallel to a vertical direction perpendicular to a surface of the road,
estimate at least one error that affects the produced navigation data, by solving a system of equations making the assumption that the at least one movement of the vehicle constitutes an error of movement of the vehicle parallel to the vertical direction,
correct the navigation data produced on the basis of the at least one error, such as to produce corrected navigation data.

9. A device for estimating navigation data of a land vehicle, the device comprising:
an interface for receiving inertial data acquired by at least one inertial sensor embedded in the land vehicle,
an interface for receiving parameters relating to a geometry and an orientation of a road travelled by the land vehicle, the parameters comprising a width of the road measured along a transverse direction perpendicular to an average direction of circulation of a land vehicle on the road,
at least one processor configured to:
integrate the inertial data on the basis of the parameters, such as to produce navigation data of the vehicle comprising at least one movement of the vehicle with respect to the road measured parallel to the transverse direction,
compute a deviation between the at least one movement of the vehicle and an associated reference movement having a predetermined value less than or equal to the width of the road,
estimate at least one error that affects the produced navigation data, by solving a system of equations making the assumption that the deviation constitutes an error of movement of the vehicle parallel to the transverse direction,
correct the navigation data produced on the basis of the at least one error, such as to produce corrected navigation data.

10. A system intended to be embedded in a land vehicle, comprising:
an inertial system comprising at least one inertial sensor,
a device as claimed in claim 8 or claim 9 arranged to receive inertial data generated by the inertial system by means of the inertial sensor.

11. A system intended to be embedded in a land vehicle, comprising:
a memory containing road data,
a receiver configured for acquiring satellite radio navigation data,
a correlating device configured for implementing a correlation between the satellite radio navigation data and the road data contained in the memory, such as to produce parameters relating to the geometry and orientation of a road,
a device as claimed in claim 8 or claim 9 arranged to receive the parameters produced by the correlating device.

12. A land vehicle comprising a device as claimed in claim 9.
